(19) United States
(12) Patent Application Publication
(10) Pub. No.: US 2023/0237777 A1
(43) Pub. Date: Jul. 27, 2023

(54) INFORMATION PROCESSING APPARATUS, LEARNING APPARATUS, IMAGE RECOGNITION APPARATUS, INFORMATION PROCESSING METHOD, LEARNING METHOD, IMAGE RECOGNITION METHOD, AND NON-TRANSITORY-COMPUTER-READABLE STORAGE MEDIUM

(71) Applicant: CANON KABUSHIKI KAISHA, Tokyo (JP)

(72) Inventor: Kenshi SAITO, Kanagawa (JP)

(21) Appl. No.: 18/157,100

(22) Filed: Jan. 20, 2023

(30) Foreign Application Priority Data
Jan. 27, 2022 (JP) 2022-011140

(51) Int. Cl. G06V 10/774; G06V 10/22; G06V 20/70; G06V 10/54

(52) U.S. Cl. CPC G06V 10/774; G06V 10/22; G06V 20/70; G06V 10/54; G06V 10/267

(57) ABSTRACT

An information processing apparatus comprises a first generation unit configured to generate a synthesized image in which a second image is synthesized in a closed region in a first image, and a second generation unit configured to generate learning data, the learning data including a label and the synthesized image, the label indicating an object region including a region corresponding to the closed region in the synthesized image.

### BACKGROUND OF THE INVENTION

### Field of the Invention

The present invention relates to a learning technology.

### Description of the Related Art

Research and development regarding an image recognition field have developed significantly, and it is not uncommon that it is used for surrounding various tools. In particular, in association with development of deep learning, multi-object detection that simultaneously detects various types of objects included in a captured images has become possible. All of Rich Feature Hierarchies for Accurate Object Detection and Semantic Segmentation., Ross Girshick et al., 2014, SSD: Single Shot MultiBox Detector, Wei Liu et al., 2015, You Only Look Once: Unified, Real-Time Object Detection, Joseph Redmon et al., 2015 disclose methods for performing multi-object detection from images using deep learning.

As an application example, deep learning may be used to obtain information for controlling various functions of a camera. As one of image capturing functions by a camera, there is an autofocus (AF) function that detects an object region near a selected region and automatically focuses the camera on a target object based on the object region. For example, as a method of selecting the region, a method of selection in which a user takes the initiative using, for example, a touch panel, and a method of automatic detection using an object detection technology are considered.

However, there are a large variety of objects that can be a subject of the camera. In multi-task detection that detects an unspecified object, it is difficult to prepare learning data so as to cover all of features of objects.

To detect an object region with limited learning data, a contour formed by a texture may be erroneously detected as a contour of the object. As a method of suppressing such erroneous detection, a method of synthesizing new learning data is considered.

As a technology to synthesize the learning data and improve accuracy of object detection, there has been a technology disclosed in Training Deep Networks with Synthetic Data: Bridging the Reality Gap by Domain Randomization, Jonathan Tremblay, et al., 2018. However, although the technology disclosed in Training Deep Networks with Synthetic Data: Bridging the Reality Gap by Domain Randomization, Jonathan Tremblay, et al., 2018 can improve detection accuracy for a specific object, learning object features of few textures is difficult.

### SUMMARY OF THE INVENTION

The present invention provides a technology for improving detection accuracy of an object region in an image.

According to the first aspect of the present invention, there is provided an information processing apparatus, comprising: a first generation unit configured to generate a synthesized image in which a second image is synthesized in a closed region in a first image; and a second generation unit configured to generate learning data, the learning data including a label and the synthesized image, the label indicating an object region including a region corresponding to the closed region in the synthesized image.

According to the second aspect of the present invention, there is provided a learning apparatus, comprising a learning unit configured to perform learning of a detection unit that detects an object region from an input image using a synthesized image included in learning data generated by a second generation unit of an information processing apparatus and a label included in the learning data, wherein the information processing apparatus includes: a first generation unit configured to generate the synthesized image in which a second image is synthesized in a closed region in a first image; and the second generation unit configured to generate the learning data, the learning data including the label and the synthesized image, the label indicating the object region including a region corresponding to the closed region in the synthesized image.

According to the third aspect of the present invention, there is provided an image recognition apparatus, comprising a detection unit configured to detect an object region from an input image using a detection unit learned by a learning apparatus that includes learning unit, the learning unit performing learning of the detection unit that detects the object region from the input image using a synthesized image included in learning data generated by a second generation unit of an information processing apparatus and a label included in the learning data, wherein the information processing apparatus includes: a first generation unit configured to generate the synthesized image in which a second image is synthesized in a closed region in a first image; and the second generation unit configured to generate the learning data, the learning data including the label and the synthesized image, the label indicating the object region including a region corresponding to the closed region in the synthesized image.

According to the fourth aspect of the present invention, there is provided a learning apparatus, comprising a learning unit configured to perform learning of a first detection unit and a second detection unit using a synthesized image included in learning data generated by a second generation unit of an information processing apparatus, a label included in the learning data, and a texture label included in the learning data, the first detection unit detecting an object region from an input image, the second detection unit detecting a region having a texture from the input image, wherein the information processing apparatus includes: a first generation unit configured to generate the synthesized image in which a second image is synthesized in a closed region in a first image; and the second generation unit configured to generate the learning data, the learning data including the label and the synthesized image, the label indicating the object region including a region corresponding to the closed region in the synthesized image, wherein the second generation unit generates the learning data including the label, the synthesized image, and the texture label indicating a region having the texture in the closed region in the synthesized image.

According to the fifth aspect of the present invention, there is provided an image recognition apparatus, comprising a formation unit configured to form a new object region using an object region detected from an input image using a first detection unit learned by a learning apparatus and a texture region detected from the input image using a second detection unit learned by the learning apparatus, the learning apparatus including a learning unit configured to perform learning of the first detection unit and the second detection unit using a synthesized image included in learning data generated by a second generation unit of an information processing apparatus, a label included in the learning data, and a texture label included in the learning data, the first detection unit detecting the object region from the input image, the second detection unit detecting a region having a texture from the input image, wherein the information processing apparatus includes: a first generation unit configured to generate the synthesized image in which a second image is synthesized in a closed region in a first image; and the second generation unit configured to generate the learning data, the learning data including the label and the synthesized image, the label indicating the object region including a region corresponding to the closed region in the synthesized image, wherein the second generation unit generates the learning data including the label, the synthesized image, and the texture label indicating a region having the texture in the closed region in the synthesized image.

According to the sixth aspect of the present invention, there is provided an information processing method performed by an information processing apparatus, the method comprising: generating a synthesized image in which a second image is synthesized in a closed region in a first image; and generating learning data including a label and the synthesized image, the label indicating an object region including a region corresponding to the closed region in the synthesized image.

According to the seventh aspect of the present invention, there is provided a learning method performed by a learning apparatus, comprising performing learning of a detection unit that detects an object region from an input image using a synthesized image included in learning data generated in an information processing method and a label included in the learning data, wherein the information processing method includes: generating the synthesized image in which a second image is synthesized in a closed region in a first image; and generating the learning data including the label and the synthesized image, the label indicating the object region including a region corresponding to the closed region in the synthesized image.

According to the eighth aspect of the present invention, there is provided an image recognition method performed by an image recognition apparatus, comprising detecting an object region from an input image using a detection unit learned by a learning method using a synthesized image included in learning data generated in an information processing method and a label included in the learning data, the learning method performing learning of the detection unit that detects the object region from the input image, wherein the information processing method includes: generating the synthesized image in which a second image is synthesized in a closed region in a first image; and generating the learning data including the label and the synthesized image, the label indicating the object region including a region corresponding to the closed region in the synthesized image.

According to the ninth aspect of the present invention, there is provided a learning method performed by a learning apparatus, comprising performing learning of a first detection unit and a second detection unit using a synthesized image included in learning data generated in an information processing method, a label included in the learning data, and a texture label included in the learning data, the first detection unit detecting an object region from an input image, the second detection unit detecting a region having a texture from the input image, wherein the information processing method includes: generating the synthesized image in which a second image is synthesized in a closed region in a first image; and generating the learning data including the label and the synthesized image, the label indicating the object region including a region corresponding to the closed region in the synthesized image, wherein the generating generates the learning data including the label, the synthesized image, and the texture label indicating a region having the texture in the closed region in the synthesized image.

According to the tenth aspect of the present invention, there is provided an image recognition method performed by an image recognition apparatus, comprising forming a new object region using an object region detected from an input image using a first detection unit learned by a learning method and a texture region detected from the input image using a second detection unit learned by the learning method, the learning method performing learning of the first detection unit and the second detection unit using a synthesized image included in learning data generated in an information processing method, a label included in the learning data, and a texture label included in the learning data, the first detection unit detecting the object region from the input image, the second detection unit detecting a region having a texture from the input image, wherein the information processing method includes: generating the synthesized image in which a second image is synthesized in a closed region in a first image; and generating the learning data including the label and the synthesized image, the label indicating the object region including a region corresponding to the closed region in the synthesized image, wherein the generating generates the learning data including the label, the synthesized image, and the texture label indicating a region having the texture in the closed region in the synthesized image.

According to the eleventh aspect of the present invention, there is provided a non-transitory-computer-readable storage medium storing a computer program to cause a computer to function as: a first generation unit configured to generate a synthesized image in which a second image is synthesized in a closed region in a first image; and a second generation unit configured to generate learning data, the learning data including a label and the synthesized image, the label indicating an object region including a region corresponding to the closed region in the synthesized image.

According to the twelfth aspect of the present invention, there is provided a non-transitory-computer-readable storage medium storing a computer program to cause a computer to function as a learning unit of a learning apparatus configured to perform learning of a detection unit that detects an object region from an input image using a synthesized image included in learning data generated by a second generation unit of an information processing apparatus and a label included in the learning data, wherein the information processing apparatus includes: a first generation unit configured to generate the synthesized image in which a second image is synthesized in a closed region in a first image; and the second generation unit configured to generate the learning data, the learning data including the label and the synthesized image, the label indicating the object region including a region corresponding to the closed region in the synthesized image.

According to the thirteenth aspect of the present invention, there is provided a non-transitory-computer-readable storage medium storing a computer program to cause a computer to function as a learning unit of a learning apparatus configured to perform learning of a first detection unit and a second detection unit using a synthesized image included in learning data generated by a second generation unit of an information processing apparatus, a label included in the learning data, and a texture label included in the learning data, the first detection unit detecting an object region from an input image, the second detection unit detecting a region having a texture from the input image, wherein the information processing apparatus includes: a first generation unit configured to generate the synthesized image in which a second image is synthesized in a closed region in a first image; and the second generation unit configured to generate the learning data, the learning data including the label and the synthesized image, the label indicating the object region including a region corresponding to the closed region in the synthesized image, wherein the second generation unit generates the learning data including the label, the synthesized image, and the texture label indicating a region having the texture in the closed region in the synthesized image.

According to the fourteenth aspect of the present invention, there is provided a non-transitory-computer-readable storage medium storing a computer program to cause a computer to function as each unit of an image recognition apparatus, the image recognition apparatus comprising a detection unit configured to detect an object region from an input image using a detection unit learned by a learning apparatus that includes a learning unit, the learning unit performing learning of the detection unit that detects the object region from the input image using a synthesized image included in learning data generated by a second generation unit of an information processing apparatus and a label included in the learning data, wherein the information processing apparatus includes: a first generation unit configured to generate the synthesized image in which a second image is synthesized in a closed region in a first image; and the second generation unit configured to generate the learning data, the learning data including the label and the synthesized image, the label indicating the object region including a region corresponding to the closed region in the synthesized image.

According to the fifteenth aspect of the present invention, there is provided a non-transitory-computer-readable storage medium storing a computer program to cause a computer to function as each unit of an image recognition apparatus, the image recognition apparatus comprising a formation unit configured to form a new object region using an object region detected from an input image using a first detection unit learned by a learning apparatus and a texture region detected from the input image using a second detection unit learned by the learning apparatus, the learning apparatus including a learning unit configured to perform learning of the first detection unit and the second detection unit using a synthesized image included in learning data generated by a second generation unit of an information processing apparatus, a label included in the learning data, and a texture label included in the learning data, the first detection unit detecting the object region from the input image, the second detection unit detecting a region having a texture from the input image, wherein the information processing apparatus includes: a first generation unit configured to generate the synthesized image in which a second image is synthesized in a closed region in a first image; and the second generation unit configured to generate the learning data, the learning data including the label and the synthesized image, the label indicating the object region including a region corresponding to the closed region in the synthesized image, wherein the second generation unit generates the learning data including the label, the synthesized image, and the texture label indicating a region having the texture in the closed region in the synthesized image.

Further features of the present invention will become apparent from the following description of exemplary embodiments with reference to the attached drawings.

### BRIEF DESCRIPTION OF THE DRAWINGS

FIG. 1 is a block diagram illustrating an exemplary hardware configuration of a learning data generation apparatus 200.

FIG. 2 is a block diagram illustrating an exemplary functional configuration of the learning data generation apparatus 200.

FIG. 3 is a block diagram illustrating an exemplary functional configuration of an image recognition apparatus 300.

FIG. 4 is a block diagram illustrating an exemplary functional configuration of a learning apparatus 400.

FIG. 5 is a flowchart of processes performed by the learning data generation apparatus 200 to generate learning data.

FIG. 6A is a diagram illustrating a captured image 601.

FIG. 6B is a diagram illustrating the captured image 601 and closed regions 603a, 603b.

FIG. 7 is a diagram illustrating an image 701 including a texture and a partial image 702 thereof.

FIG. 8 is a block diagram illustrating an exemplary functional configuration of a determination unit 202.

FIG. 9A is a diagram illustrating an example of a synthesized image.

FIG. 9B is a diagram illustrating an example of an object region output by a detection unit 302.

FIG. 9C is a diagram illustrating an example of the object region output by the detection unit 302.

FIG. 10 is a flowchart of a learning process of the detection unit 302 by the learning apparatus 400.

FIG. 11 is a flowchart of a process performed to detect the object region in an input image by the image recognition apparatus 300.

FIG. 12 is a block diagram illustrating an exemplary functional configuration of an image recognition apparatus 1200.

FIG. 13 is a diagram illustrating an input image 1301, a texture pattern 1302, a texture region 1303, an object region 1304, and an object region 1305.

FIG. 14 is a flowchart of an operation of the image recognition apparatus 1200 for detecting the object region from the input image.

FIG. 15 is a block diagram illustrating an exemplary functional configuration of a learning apparatus 1500.

FIG. 16 is a flowchart of a learning process of a texture generation unit 1502 and a texture identification unit 1504.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

### First Embodiment

In the present embodiment, description will be given of a learning data generation apparatus as one example of an information processing apparatus that generates a synthesized image in which a second image is synthesized in a closed region in a first image, and outputs data including a label and the synthesized image as learning data. The label indicates a corresponding region corresponding to the closed region in the synthesized image.

First, an exemplary hardware configuration of a learning data generation apparatus 200 according to the present embodiment will be described using a block diagram of FIG. 1. Note that the hardware configuration applicable to the learning data generation apparatus 200 is not limited to the configuration illustrated in FIG. 1, and can be changed/modified as appropriate.

A CPU 101 executes various processes using computer programs and data stored in a memory 102. Accordingly, the CPU 101 controls the entire operation of the learning data generation apparatus 200 and performs or controls various processes described as being performed by the learning data generation apparatus 200.

The memory 102 includes an area for storing computer programs and data loaded from a storage unit 104, and an area for storing data received from outside via a communication unit 106. Additionally, the memory 102 also includes a work area used when the CPU 101 performs various processes. In this way, the memory 102 can provide the various areas as appropriate.

An input unit 103, which is a user interface, such as a keyboard, a mouse, or a touch panel screen, is operated by a user to allow inputting various instructions to the CPU 101.

The storage unit 104 is a large-capacity information storage apparatus, such as a hard disk drive apparatus. The storage unit 104 stores, for example, an operating system (OS) and computer programs and data for the CPU 101 to perform or control various processes described as being performed by the learning data generation apparatus 200. The computer programs and data stored in the storage unit 104 are loaded into the memory 102 as appropriate according to the control by the CPU 101 and to be processed by the CPU 101.

A display unit 105 is a display apparatus including a liquid crystal screen or a touch panel screen, displays the results of processes by the CPU 101 using, for example, images and characters, and receives an operation input (such as a touch operation and a swipe operation) from a user.

The communication unit 106 is a communication interface for performing data communication with an external device via a wired and/or wireless network, such as LAN and the Internet. The CPU 101, the memory 102, the input unit 103, the storage unit 104, the display unit 105, and the communication unit 106 are all connected to a system bus 107.

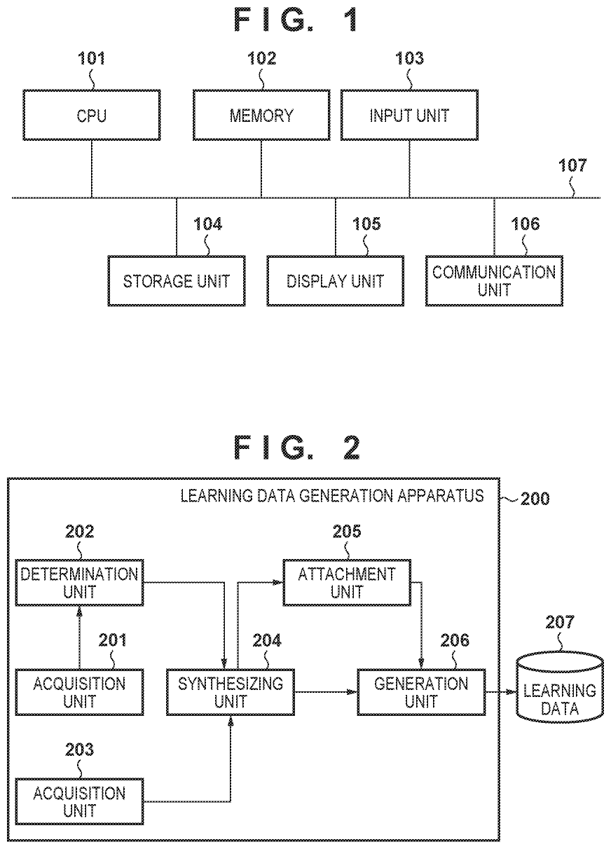

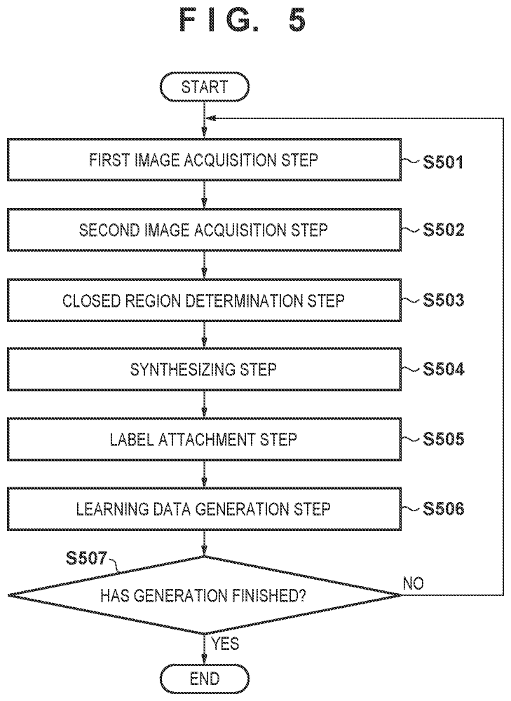

The block diagram in FIG. 2 illustrates an exemplary functional configuration of the learning data generation apparatus 200. In the present embodiment, each of all of the functional units illustrated in FIG. 2 is implemented in a computer program. In the following, the functional units in FIG. 2 will be described as the main process, but in practice, the CPU 101 executes the computer program corresponding to each of the functional units, thereby performing the function of the functional unit. The functional units illustrated in FIG. 2 may be implemented by hardware. The process performed to generate the learning data by the learning data generation apparatus 200 will be described according to the flowchart of FIG. 5.

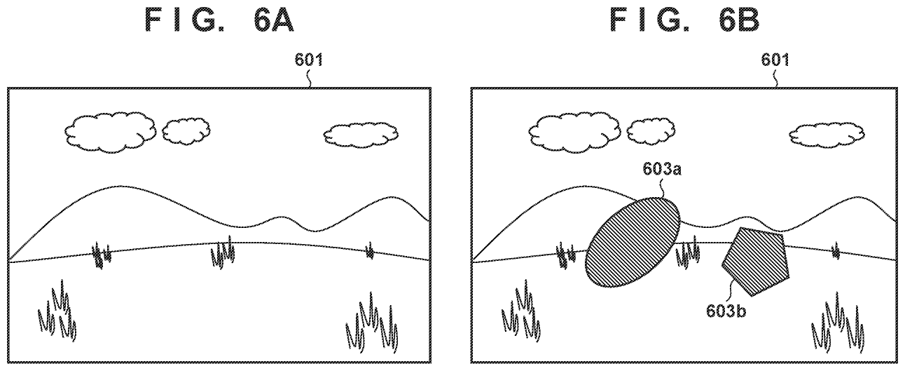

In Step S501, an acquisition unit 201 acquires a first image (background image). The first image may be, for example, a captured image 601 obtained by capturing a scene as illustrated in FIG. 6A, or may be an image obtained by synthesizing another image (for example, a background image or a CG image that is not actually present) in the captured image. The acquisition unit 201 may acquire such a first image from the storage unit 104, or may be received and acquired from an external device via the communication unit 106. The acquisition unit 201 may acquire the processed acquired image as the first image. Thus, the acquisition method of the first image is not limited to a specific acquisition method. The same applies to various images described later.

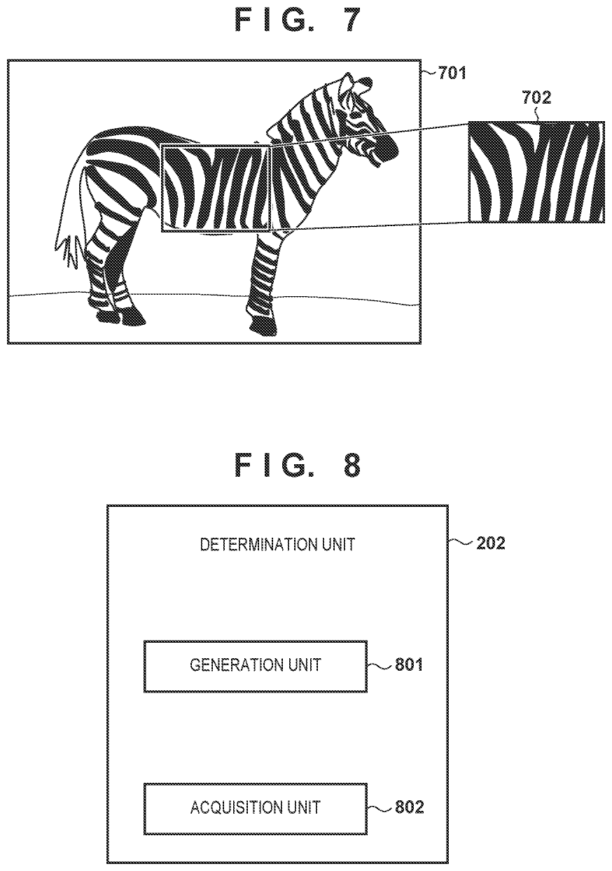

In Step S502, an acquisition unit 203 acquires a second image (texture image). The second image is an image that includes an appropriate texture. For example, the acquisition unit 203 may acquire an image 701 including a zebra having a striped pattern texture as illustrated in FIG. 7 as the second image, or may acquire a partial image 702, which is a cutout of an image region in the texture portion in the image 701 as the second image.

In Step S503, a determination unit 202 sets one or more closed regions on the first image. For example, as illustrated in FIG. 6B, the determination unit 202 sets an elliptical closed region 603a and a pentagonal closed region 603 on a background image 601. As illustrated in FIG. 8, the determination unit 202 includes one or more among a generation unit 801 and an acquisition unit 802.

The generation unit 801 generates the closed region using a geometric figure that has a shape, such as a circle, an ellipse, and a polygon, and sets the generated closed region to a position (e.g., may be a predetermined position or may be a position specified by the user using the input unit 103) on the first image. Note that the generation unit 801 may set a two-dimensional projection region in which a virtual object (three-dimensional model) having a three-dimensional shape is projected on the first image as the closed region. In addition, the generation unit 801 may set the two-dimensional region specified on the first image by the operation of the input unit 103 by the user as the closed region.

The acquisition unit 802 acquires a contour (shape) of the object included in the first image, and sets a region surrounding the acquired contour as the closed region. Note that there are various methods as a method of setting the closed region on the first image based on the contour (shape) of the object included in the first image, and the method is not limited to a specific method.

In any case, the closed region set at Step S503 is configured to be close to a shape of an object not belonging to an object category that is easily obtained to be able to expect an effect of improving detection accuracy of the object not belonging to the object category that is easily obtained.

In Step S504, a synthesizing unit 204 synthesizes the second image in the closed region on the first image and generates it as a synthesized image.

For example, in a case where one second image is acquired in Step S502, the synthesizing unit 204 cuts out a partial image having the same shape and the same size as those of the closed region from an appropriate position in the second image, and synthesizes the partial image in the closed region. In a case where a plurality of the closed regions are set in the first image, a similar process is performed on each closed region to ensure synthesizing the second image in each closed region.

In addition, for example, in a case where two or more second images are acquired in Step S502, the synthesizing unit 204 cuts out a partial image having the same shape and the same size as those of the closed region from an appropriate position at a part or all of the two or more second images, synthesizes the partial image to generate a synthesized part image. Then, the synthesizing unit 204 synthesizes the synthesized part image in the closed region. In a case where a plurality of the closed regions are set in the first image, a similar process is performed on each closed region to ensure synthesizing the second image in each closed region.

For example, in a case where one second image is acquired in Step S502, the synthesizing unit 204 cuts out a plurality of partial images having the same shape and the same size as those of the closed region from the one second image, and synthesizes the plurality of cut out partial images to generate a synthesized part image. Then, the synthesizing unit 204 synthesizes the synthesized part image in the closed region. In a case where a plurality of closed regions are set in the first image, a similar process is performed on each closed region to ensure synthesizing the second image in each closed region.

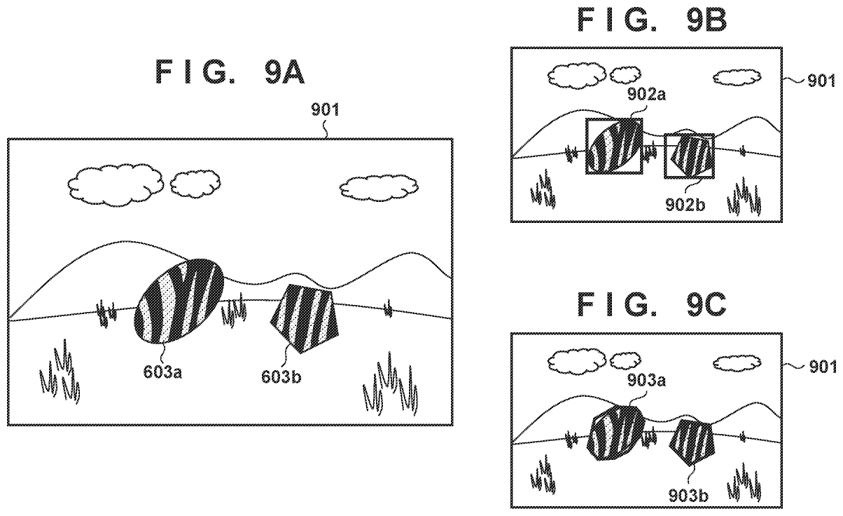

FIG. 9A illustrates an example of the synthesized image in which the image 701 of FIG. 7 is synthesized in the closed region 603a and the closed region 603b in the background image 601 of FIG. 6B. The partial image cut out from an appropriate position in the image 701 in accordance with the size and shape of the closed region 603a is synthesized in the closed region 603a in a synthesized image 901. The partial image cut out from an appropriate position in the image 701 in accordance with the size and shape of the closed region 603b is synthesized in the closed region 603b in the synthesized image 901.

Note that the method of synthesizing the image is not limited to a specific synthesizing method. For example, pixel values in the synthesized image may be a logical sum of pixel values of the respective images of the synthesization subject. Synthesization may be performed by a method, such as alpha blending.

In Step S505, an attachment unit 205 generates a label for teaching a detection unit 302 described later with the closed region in which the second image is synthesized in the synthesized image as a region (object region) of one detection target object. For example, when the closed region is set as the region of the detection target object, the attachment unit 205 attaches 1 as a label to the region equivalent to the object region to be output by the detection unit 302 and attaches 0 to regions other than the region.

For example, the object regions output by the detection unit 302 to which the synthesized image 901 is input are, as illustrated in FIG. 9B, a rectangular region 902a that is circumscribed to the closed region 603a and a rectangular region 902b that is circumscribed to the closed region 603b. In addition, for example, the object regions output by the detection unit 302 to which the synthesized image 901 is input are, as illustrated in FIG. 9C, a polygonal region 903a that is inscribed or circumscribed to the closed region 603a and a polygonal region 903b that is circumscribed to the closed region 603b.

Thus, the attachment unit 205 outputs “1” as a label corresponding to a pixel constituting a corresponding region (the rectangular regions 902a, 902b and the polygonal regions 903a, 903b in the examples of FIG. 9A to FIG. 9C) corresponding to the closed region in the synthesized image. The attachment unit 205 outputs “0” as a label corresponding to the pixel constituting the other region except the corresponding region.

In Step S506, a generation unit 206 generates learning data 207 including the synthesized image and a label map including the labels corresponding to the respective pixels in the synthesized image and stores the generated learning data 207 in the storage unit 104. Note that the output destination of the learning data 207 is not limited to the storage unit 104, and may be output to a device that can communicate with a learning apparatus 400 described later, or may be directly output to the learning apparatus 400.

In Step S507, the CPU 101 determines whether a termination condition of generating the learning data is satisfied. The termination condition of generating the learning data is not limited to a specific condition. For example, in a case where a label map corresponding to a predetermined stipulated number of synthesized images is generated, the CPU 101 determines that the termination condition is satisfied.

As a result of such a determination, when the termination condition of generating the learning data is satisfied, the process according to the flowchart of FIG. 5 is terminated. On the other hand, when the termination condition of generating the learning data is not satisfied, the process proceeds to Step S501.

Next, the learning apparatus 400 that performs learning of the detection unit 302 using the learning data generated in this manner will be described. In the present embodiment, the hardware configuration of the learning apparatus 400 is the configuration illustrated in FIG. 1, similarly to the learning data generation apparatus 200, but may be a configuration different from the configuration illustrated in FIG. 1.

Accordingly, the CPU 101 performs various processes using computer programs and data stored in the memory 102 to control the entire operation of the learning apparatus 400 and also performs or controls various processes described as being performed by the learning apparatus 400. The storage unit 104 stores, for example, an operating system (OS) and computer programs and data for the CPU 101 to perform or control various processes described as being performed by the learning apparatus 400. The other configurations are similar to the learning data generation apparatus 200.

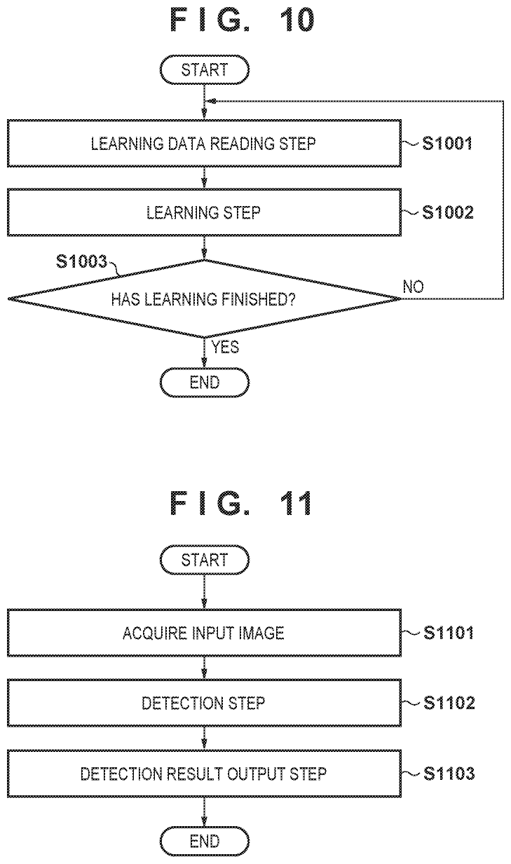

Next, an exemplary functional configuration of the learning apparatus 400 is illustrated in the block diagram of FIG. 4. The learning process of the detection unit 302 by the learning apparatus 400 will be described according to the flowchart of FIG. 10. In Step S1001, an acquisition unit 401 acquires the learning data 207 stored in the storage unit 104. Note that in Step S1001, the acquisition unit 401 is not limited to acquiring only the learning data 207 generated by the learning data generation apparatus, and may acquire learning data generated by another device.

In Step S1002, a learning unit 402 performs learning of the detection unit 302 using the learning data 207 acquired by the acquisition unit 401. Various ones, for example, a neural network, such as a convolutional neural network (CNN), Vision Transformer (ViT), and a support vector machine (SVM) in combination with a feature extractor are considered as the detection unit 302. In the present embodiment, for specific description, a case of the detection unit 302 being a CNN will be described.

The learning unit 402 inputs the synthesized image included in the learning data 207 to the CNN to perform arithmetic processing in the CNN, and thus acquires the detection result of the object region in the synthesized image as the output of the CNN. Then, the learning unit 402 obtains an error between the detection result of the object region in the synthesized image and the label included in the learning data 207, and updates a parameter (such as a weight) of the CNN so as to further decrease the error, thus performing learning of the detection unit 302 is performed.

In Step S1003, the learning unit 402 determines whether the termination condition of learning is satisfied. The termination condition of learning is not limited to a specific condition. For example, when the above-described error is less than a threshold value, the learning unit 402 may determine that the termination condition of learning is satisfied. In addition, for example, when the difference between the previously obtained error and the error obtained this time (an amount of change of error) is less than the threshold value, the learning unit 402 may determine that the termination condition of learning is satisfied. For example, when the number of learnings (the number of repetitions of Steps S1001 and S1002) exceeds the threshold value, the learning unit 402 may determine that the termination condition of learning is satisfied.

As a result of such a determination, when the termination condition of learning is satisfied, the process according to the flowchart of FIG. 10 is terminated. On the other hand, when the termination condition of learning is not satisfied, the process proceeds to Step S1001, and subsequent processes are performed on the next learning data.

Next, an image recognition apparatus 300 for detecting the object region from the input image using the detection unit 302 learned in this manner will be described. In the present embodiment, the hardware configuration of the image recognition apparatus 300 is the configuration illustrated in FIG. 1, similarly to the learning data generation apparatus 200, but may be a configuration different from the configuration illustrated in FIG. 1.

That is, the CPU 101 executes various processes using computer programs and data stored in the memory 102. Accordingly, the CPU 101 controls the operation of the entire image recognition apparatus 300 and performs or controls various processes described as being performed by the image recognition apparatus 300. The storage unit 104 stores, for example, an operating system (OS) and computer programs and data for the CPU 101 to perform or control various processes described as being performed by the image recognition apparatus 300. The other configurations are similar to the learning data generation apparatus 200.

For example, the image recognition apparatus 300 is applicable to an object detection circuit for autofocus control in an image capturing apparatus, such as a digital camera, and a program that detects an object for use in image processing in a tablet terminal, such as a smartphone. Thus, the image recognition apparatus 300 is not limited to specific configuration.

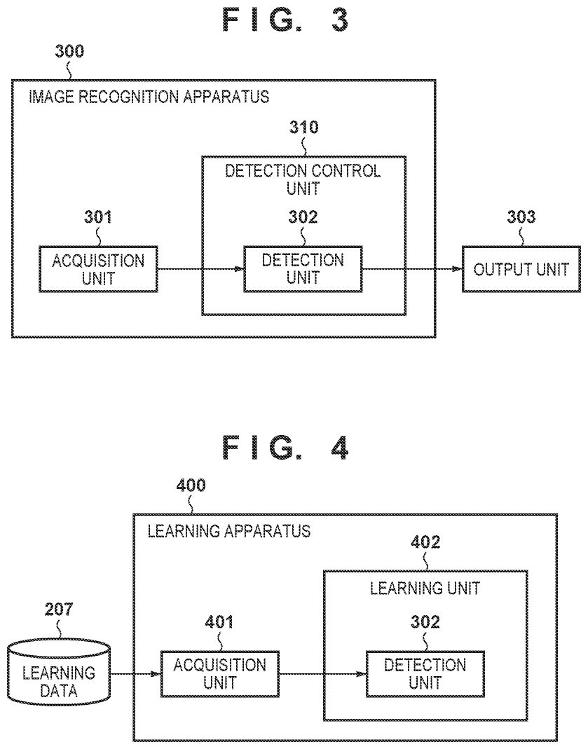

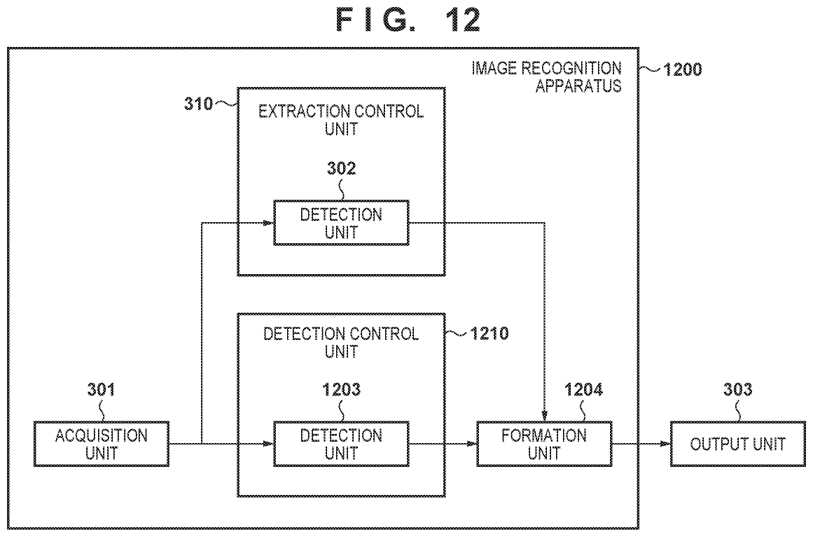

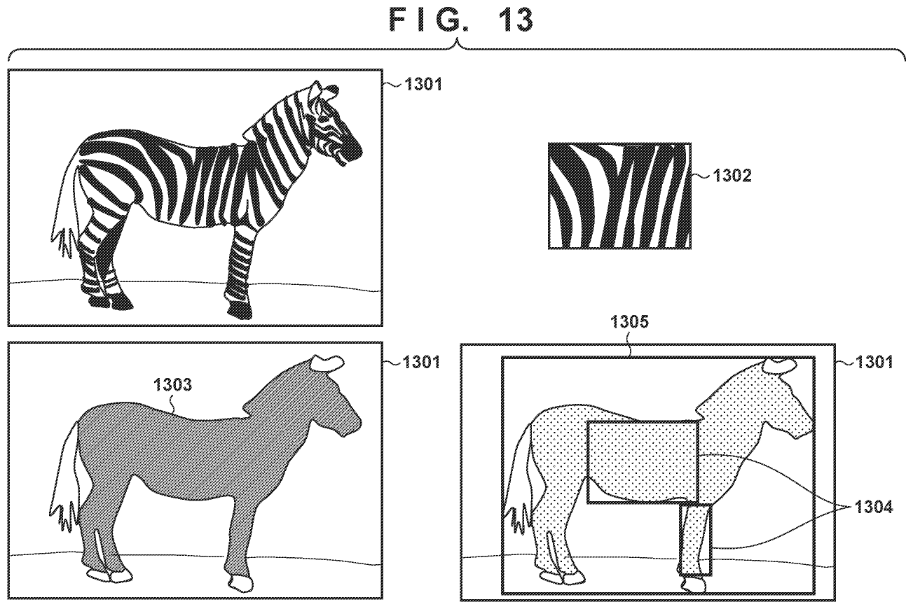

An exemplary functional configuration of the image recognition apparatus 300 is illustrated in the block diagram of FIG. 3. The process performed for the image recognition apparatus 300 to detect the object region in the input image using the detection unit 302 learned by the learning apparatus 400 will be described according to the flowchart of FIG. 11.

In Step S1101, an acquisition unit 301 acquires the input image target for object detection. In Step S1102, a detection control unit 310 inputs an input image to the detection unit 302 and performs arithmetic processing of the detection unit 302, thus acquiring the output of the detection unit 302 of the input image, that is, the detection result of the object region in the input image. An output map obtained by forward propagation of the CNN being the detection unit 302 corresponds to “the detection result of the object region in the input image.” “The detection result of the object region in the input image” is the object region expressed by a coordinate and likelihood of the object in the input image. “A coordinate of the object in the input image” is position information on the input image specified by, for example, a rectangle and an ellipse, and when it is a rectangle, the coordinate can be represented by the center position of the rectangle and the size of the rectangle.

In Step S1103, an output unit 303 outputs “the detection result of the object region in the input image” acquired in Step S1102. The output destination of “the detection result of the object region in the input image” is not limited to a specific output destination. For example, the output unit 303 may display an input image on the display unit 105, overlay a frame of an object region having a position and a size indicated by “the detection result of the object region in the input image” with the input image, and display it. Furthermore, the output unit 303 may further cause the display unit 105 to display the position and size indicated by “the detection result of the object region in the input image” as a text. The output unit 303 may transmit “the detection result of the object region in the input image” to an external device via the communication unit 106. In a case where the image recognition apparatus 300 is an apparatus incorporated in the image capturing apparatus, the output unit 303 may output “the detection result of the object region in the input image (in this case, the input image is a captured image captured by the image capturing apparatus) to a control circuit, such as the CPU 101. In this case, the control circuit can focus and track the object in the object region having the position and size indicated by “the detection result of the object region in the input image.”

### Effects of First Embodiment

The learning data generated by the learning data generation apparatus 200 is learning data including an object having a shape and a texture that are not actually captured. A contour created by the texture being not the contour of the object is taught with the label to ensure improving detection accuracy of the object region of the object that is not actually captured as the learning data. Therefore, the effect of improving accuracy can be obtained in multi-task detection that detects the object region of any object. Also, it is also possible to expect an effect of suppressing that a part of or all of a contour created in a pattern is erroneously detected as the contour of the object when the object having a regular texture is detected.

### Second Embodiment

In the following embodiments including the present embodiment, difference from the first embodiment will be described, assuming that the following embodiments are similar to the first embodiment unless otherwise specified. In the present embodiment, a specific texture pattern is also detected in addition to detecting the object region. An exemplary functional configuration of an image recognition apparatus 1200 according to the present embodiment is illustrated in the block diagram of FIG. 12. In FIG. 12, the functional units that perform operations similar to those of the functional units illustrated in FIG. 3 are denoted by the same reference numerals.

A detection control unit 1210 inputs the input image acquired by the acquisition unit 301 to a detection unit 1203 to operate the detection unit 1203. The detection unit 1203 detects a texture region in which a prescribed texture pattern is present from the input image.

A formation unit 1204 acquires the detection result of the object region by the detection unit 302 and the detection result of the texture region by the detection unit 1203, and forms a new object region in the input image based on the object region and the texture region. The output unit 303 outputs information indicating the object region formed by the formation unit 1204 (for example, the position and size of the object region in the input image).

The following points are different from the first embodiment in generation of the learning data used for learning of the detection unit 302 for achieving such an operation. The learning data generation apparatus 200 performs processes according to the flowchart of FIG. 5, and performs the following process in Step S505.

In Step S505, the attachment unit 205 handles a region (a part or all of the closed regions) having a texture in the closed region in which the second image is synthesized in the synthesized image as a texture region and generates a texture label for teaching the texture region to the detection unit 1203 described later. For example, it is assumed that both of the closed regions 603a, 603b in the synthesized image 901 of FIG. 9A to FIG. 9C are constituted by one texture pattern. In this case, the attachment unit 205 outputs “1” as a texture label corresponding to each pixel constituting the region (for example, rectangular regions 902a, 902b and polygonal regions 903a, 903b) equivalent to the texture region to be output by the detection unit 1203. The attachment unit 205 outputs “0” as a texture label corresponding to each pixel constituting the region other than the region (for example, the rectangular regions 902a, 902b and the polygonal regions 903a, 903b) equivalent to the texture region to be output by the detection unit 1203.

In Step S506, the generation unit 206 generates the learning data 207 including the synthesized image, the label map including labels corresponding to the respective pixels in the synthesized image, and a texture label map including texture labels corresponding to the respective pixels in the synthesized image, and stores the generated learning data 207 in the storage unit 104.

The learning apparatus 400 performs learning of the detection unit 302 and the detection unit 1203 using the learning data generated in this manner, and the following points are different from the first embodiment. In other words, the learning apparatus 400 performs processes according to the flowchart of FIG. 10, and performs the following process in Step S1002.

In Step S1002, the learning unit 402 performs learning of the detection unit 302 in the same manner as in the first embodiment using the learning data generated as described above. Furthermore, the learning unit 402 also performs learning of the detection unit 1203 using the learning data generated as described above. Various ones, for example, a neural network, such as a CNN, a ViT, and an SVM in combination with a feature extractor are considered as the detection unit 1203. Learning of the detection unit 1203 performs learning such that the region (texture region) with the texture label “1” in the synthesized image is taught to the detection unit 1203, the detection unit 1203 is caused to learn the texture pattern of the region, and the region with the texture pattern similar to the texture pattern of the region is detected. When the detection unit 1203 is a neural network, a parameter, such as a weight, is updated to perform learning of the detection unit 1203. Since the technology performing learning of the detection unit so as to detect the region having a predetermined feature in the input image is well known, description regarding the learning will be omitted.

At this time, performing learning of the detection unit 1203 using the texture pattern that is erroneously detected in the detection unit 302 according to the first embodiment as the texture pattern allows the detection unit 1203 to detect a texture region that allows correcting the detection result of the object region. The use of the texture region detected by the detection unit 1203 allows correcting the object region detected by the detection unit 302 so as to be a more accurate object region.

Next, the operation of the image recognition apparatus 1200 for detecting the object region from the input image using the detection unit 302 and the detection unit 1203 obtained by such a learning process will be described according to the flowchart of FIG. 14. In FIG. 14, process steps same as process steps depicted in FIG. 11 bear the same step numbers thereof.

In Step S1100, the acquisition unit 301 acquires the input image target for object detection. In Step S1102, the detection control unit 310 inputs the input image to the detection unit 302 and performs arithmetic processing of the detection unit 302, thus acquiring the detection result of the object region in the input image.

In Step S1401, the detection control unit 1210 inputs the input image to the detection unit 1203 and operates the detection unit 1203 to detect “the texture region having the texture pattern similar to the texture pattern learned by the detection unit 1203” from the input image.

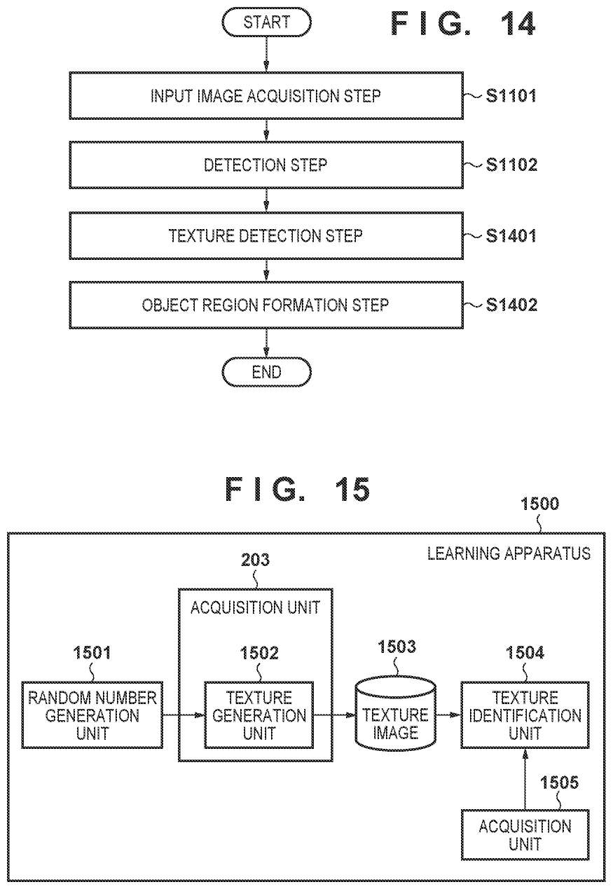

For example, it is assumed that the learning of the detection unit 1203 is performed using a texture pattern 1302 in FIG. 13. In this case, when the input image 1301 illustrated in FIG. 13 as an example is input to the detection unit 1203, the detection unit 1203 detects the texture region 1303 in the texture pattern similar to the texture pattern 1302 in the input image 1301. The detection unit 1203 outputs a map representing the position and likelihood of the texture region 1303 in the input image 1301.

In Step S1402, the formation unit 1204 forms a new object region in the input image based on the detection result of the object region by the detection unit 302 and the detection result of the texture region by the detection unit 1203.

Here, an example of a method for forming the new object region by the formation unit 1204 will be described. Below, a case in which the detection unit 302 detects one or more rectangular object regions from the input image, and the detection unit 1203 outputs the likelihood (a real number between 0 and 1) that each rectangular region belongs to the texture region when the input image is divided into a plurality of the rectangular regions (the input image is divided into a plurality of the rectangular regions in a grid pattern) will be described.

In this case, the formation unit 1204 obtains a sum S of the likelihood corresponding to the rectangular regions belonging to the object region for each of the object regions. When the sum S obtained for the object region is relatively larger than the size of the object region, the formation unit 1204 determines that the object region includes more texture patterns. For example, with an area (the number of pixels) of the object region as A, the formation unit 1204 determines that the object region where S/A is a threshold value or more includes more texture patterns. In the example of FIG. 13, both of the object regions 1304 in the input image are object regions in which “the sum S obtained for the object region is relatively larger than the size of the object region.”

Here, as illustrated in FIG. 13, when an object region 1305 surrounding the object regions 1304 is detected, it is highly possibly a further accurate object detection result that the object region 1305 surrounding the object regions 1304 surrounds the whole object rather than the object regions 1304, which possibly include many texture patterns. Thus, the formation unit 1204 excludes the object region corresponding to “the smaller object region among the object regions having an inclusion relationship with another object region” even the object region in which “the sum S obtained for the object region is relatively larger than the size of the object region” among the object regions detected by the detection unit 302. As a result of the exclusion, the formation unit 1204 handles the remaining object region as “the new object region” to output the further accurate object region surrounding the whole target object.

Note that, in a case where the object region (target) in which “the sum S obtained for the object region is relatively larger than the size of the object region” is not “the object region having an inclusion relationship with another object region,” the formation unit 1204 handles the target as “the new object region.” The output unit 303 outputs information indicating “the new object region” configured by the formation unit 1204 (for example, the position and size of the object region in the input image).

Note that in the present embodiment, the detection unit 302 and the detection unit 1203 are separate detection units, but the detection unit 302 and the detection unit 1203 may be implemented in one neural network by operating the one neural network while parameters are switched.

### Effects of Second Embodiment

According to the present embodiment, the region of the texture pattern similar to the learned texture pattern can be detected separately from the object region. This allows obtaining an effect that even with an object having an unknown shape that is not learned, the contour created by the texture and the contour of the object are less likely to be erroneously detected. Therefore, the effect of improving accuracy can be obtained in multi-task detection that detects the object region of any object.

### Third Embodiment

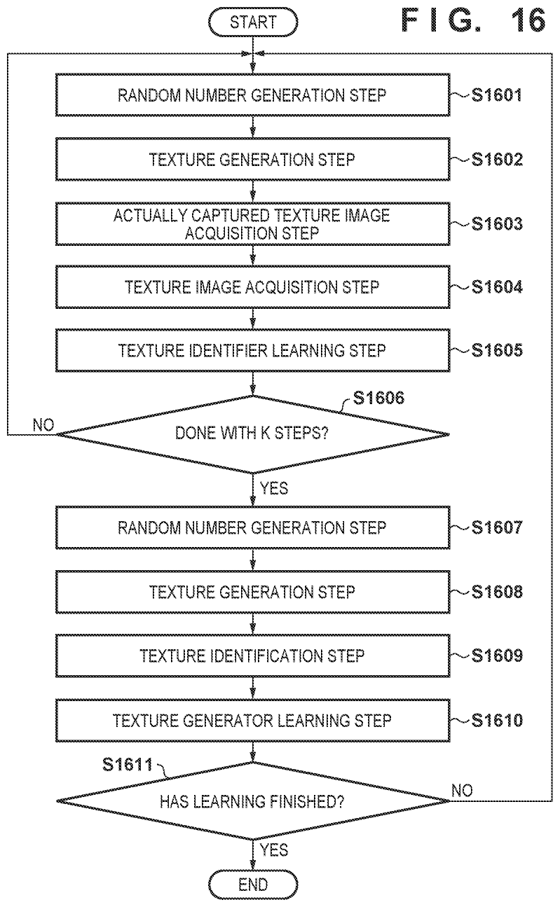

In the present embodiment, the acquisition unit 203 generates a texture image that is the most likely to be the second image. As illustrated in FIG. 15, the acquisition unit 203 according to the present embodiment includes a texture generation unit 1502 that is learned to output a texture image that is the most likely to correspond to a random number or a random number vector. This learning is performed by a learning apparatus 1500. The learning apparatus 1500 will be described below.

In the present embodiment, the hardware configuration of the learning apparatus 1500 is the configuration illustrated in FIG. 1, similarly to the learning data generation apparatus 200, but may be a configuration different from the configuration illustrated in FIG. 1. That is, the CPU 101 performs various processes using the computer programs and the data stored in the memory 102 to control the operation of the entire learning apparatus 1500 and performs or controls various processes described as being performed by the learning apparatus 1500. The storage unit 104 stores, for example, an operating system (OS) and computer programs and data for the CPU 101 to perform or control various processes described as being performed by the learning apparatus 1500. The other configurations are similar to the learning data generation apparatus 200.

FIG. 15 illustrates an exemplary functional configuration of the learning apparatus 1500. The learning apparatus 1500 also performs learning of a texture identification unit 1504 in addition to the learning of the texture generation unit 1502 as described above. In learning in the learning apparatus 1500, a generative adversarial network (GAN) is used. Then, the texture generation unit 1502 handles Generator, and the texture identification unit 1504 handles Discriminator.

The learning process of the texture generation unit 1502 and the texture identification unit 1504 in the learning apparatus 1500 will be described in accordance with the flowchart of FIG. 16. In Step S1601, a random number generation unit 1501 generates one or more random numbers or random number vectors.

In Step S1602, the texture generation unit 1502 generates a texture image 1503 from the random number or the random number vector generated in Step S1601 and outputs it. The texture generation unit 1502 is configured by CNN or ViT, inputs the random number or the random number vector, performs arithmetic processing, and outputs the texture image 1503. The texture image 1503 corresponds to an output map output from the CNN, for example, and is an image having the number of channels similar to the learning data 207 or a gray scale image having one channel.

In Step S1603, an acquisition unit 1505 acquires an actually captured texture image having a texture feature desired to be learned by the texture generation unit 1502 and that is actually captured, and outputs the acquired actually captured texture image.

In Step S1604, the texture identification unit 1504 acquires the texture image output from the texture generation unit 1502 and the actually captured texture image output from the acquisition unit 1505. The texture identification unit 1504 is configured by CNN or ViT similar to the texture generation unit 1502.

The learning apparatus 1500 performs learning of the texture generation unit 1502 and the texture identification unit 1504 using the learning apparatus 400 (learning unit 402) described above, and in Step S1605, the learning process of the texture identification unit 1504 is performed.

The learning data used in learning of the texture identification unit 1504 includes the texture image 1503, a teacher value (first teacher value) indicating the texture image 1503 being the image generated by the texture generation unit 1502, the actually captured texture image acquired by the acquisition unit 1505, and a teacher value (second teacher value) indicating the actually captured texture image being the image acquired by the acquisition unit 1505. Learning of the texture identification unit 1504 is performed using the learning data. In other words, the learning apparatus 400 inputs the texture image or the actually captured texture image to the texture identification unit 1504 as the input image, and uses the teacher value (identified by the first teacher value and the second teacher value, 0 or 1) as teacher data indicating whether the input image is a texture image or an actually captured texture image to perform learning of the texture identification unit 1504. Through the learning, the texture identification unit 1504 improves accuracy of identifying whether the input texture image is the texture image generated by the texture generation unit 1502 or the actually captured texture image.

In Step S1606, the learning apparatus 1500 determines whether processes in Steps S1601 to S1605 have been repeated K (K is an integer of 2 or more) times. As a result of the determination, when the processes of Steps S1601 to S1605 have been repeated K times, the process proceeds to Step S1607. On the other hand, in a case where the processes of Steps S1601 to S1605 have not been repeated by K (K is an integer of 2 re more) times, the process proceeds to Step S1601.

In Step S1607, the random number generation unit 1501 generates a random number of one or more or a random number vector. In Step S1608, the texture generation unit 1502 generates the texture image 1503 from the random number or the random number vector generated in Step S1607 in the same manner as in Step S1602 described above and outputs it.

In Step S1609, the texture identification unit 1504 inputs the texture image 1503 output from the texture generation unit 1502, and performs arithmetic processing. In this way, the texture identification unit 1504 acquires the identification result of whether the texture image 1503 is the image generated by the texture generation unit 1502 or the actually captured texture image acquired by the acquisition unit 1505. For example, when the texture identification unit 1504 identifies that the texture image 1503 is the image generated by the texture generation unit 1502, the texture identification unit 1504 outputs “1” as the identification result. When the texture identification unit 1504 identifies that the texture image 1503 is the actually captured texture image acquired by the acquisition unit 1505, the texture identification unit 1504 outputs “0” as the identification result.

In Step S1610, the learning apparatus 1500 performs the learning process of the texture generation unit 1502 using the learning apparatus 400 (learning unit 402) described above. The learning data used for learning of the texture generation unit 1502 includes the random number or the random number vector generated in Step S1607 and the identification result in Step S1609. The learning of the texture generation unit 1502 is performed using the learning data. In other words, the learning apparatus 400 performs learning of the texture generation unit 1502 such that the identification result of the texture identification unit 1504 for the texture image generated based on the random number or the random number vector by the texture generation unit 1502 becomes “the actually captured texture image.” Through the learning, the texture generation unit 1502 learns so as to generate the texture image 1503 to be incorrectly identified as the actually captured texture image by the texture identification unit 1504.

In Step S1611, the learning apparatus 1500 determines whether the termination condition (learning termination condition) for the processes in Steps S1601 to S1610 described above is satisfied. The learning termination condition is not limited to a specific condition, similar to the “termination condition of learning” described in the first embodiment.

As the result of determination, when the learning termination condition is satisfied, the processes according to the flowchart in FIG. 16 are terminated. On the other hand, when the learning termination condition is not satisfied, the process proceeds to Step S1601.

When the processes according to the flowchart of FIG. 16 are terminated, the texture generation unit 1502 can generate the most likely texture image 1503 corresponding to the given random number or random number vector.

### Effects of Third Embodiment

The acquisition unit 203 including the learned texture generation unit 1502 is not limited to obtaining the actually captured texture image, which is actually captured, but can obtain a new texture image having a feature of the texture image. The learning data generated by the learning data generation apparatus 200 can teach more various textures to the detection unit 302. Therefore, when the detection unit 302 is learned, the probability that the contour created with more various textures is erroneously detected as a contour of an object is reduced. Thus, the effect of improving the detection accuracy of the image recognition apparatus is obtained.

For example, the numerical values, timing of processing, order of processing, entity of processing, and structure/transmission destination/transmission source/storage location of data (information) used in the respective embodiments described above are taken as an example for providing specific explanation, and are not intended to limit the invention to such an example.

Alternatively, some or all of the embodiments described above may be used in combination as appropriate. Alternatively, some or all of the embodiments described above may be selectively used.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-011140, filed Jan. 27, 2022, which is hereby incorporated by reference herein in its entirety.

What is claimed is:

1. An information processing apparatus, comprising:
a first generation unit configured to generate a synthesized image in which a second image is synthesized in a closed region in a first image; and
a second generation unit configured to generate learning data, the learning data including a label and the synthesized image, the label indicating an object region including a region corresponding to the closed region in the synthesized image.

2. The information processing apparatus according to claim 1, wherein
the first generation unit acquires an image having a texture as the second image, and the first generation unit generates a synthesized image in which the second image is synthesized in the closed region in the first image.

3. The information processing apparatus according to claim 1, wherein
the first generation unit generates a closed region using a geometric figure, sets the generated closed region on the first image, and generates a synthesized image in which the second image is synthesized in the closed region.

4. The information processing apparatus according to claim 1, wherein
the first generation unit generates a synthesized image in which the second image is synthesized in a two-dimensional projection region in which a virtual object having a three-dimensional shape is projected on the first image.

5. The information processing apparatus according to claim 1, wherein
the first generation unit generates a synthesized image in which the second image is synthesized in a closed region set in the first image in response to an operation by a user.

6. The information processing apparatus according to claim 1, wherein
the first generation unit generates a synthesized image in which the second image is synthesized in a closed region surrounding a contour of an object in the first image.

7. The information processing apparatus according to claim 1, wherein
the first generation unit generates a synthesized image in which the second image is synthesized in each closed region in the first image.

8. The information processing apparatus according to claim 1, wherein
the first generation unit generates a synthesized image in which a plurality of the second images are synthesized in the closed region in the first image.

9. The information processing apparatus according to claim 1, wherein
the second generation unit generates learning data, the learning data includes the label, the synthesized image, and a texture label, and
the texture label indicates a region having a texture in the closed region in the synthesized image.

10. The information processing apparatus according to claim 1, comprising
an acquisition unit configured to acquire the second image, the second image being formed by cutting out a portion including a texture pattern in a shape same as a shape of the closed region from a third image including the texture pattern.

11. The information processing apparatus according to claim 10, comprising
an identification unit configured to identify whether an input image is a texture image generated by third generation unit or an actually captured texture image, wherein
the acquisition unit acquires the texture image as the second image using a generative adversarial network that generates the texture image, and
the acquisition unit acquires a texture image generated by a learned generation unit as the second image such that the texture image generated according to a random number or a random number vector is identified as being the actually captured texture image by the identification unit.

12. A learning apparatus, comprising
a learning unit configured to perform learning of a detection unit that detects an object region from an input image using a synthesized image included in learning data generated by a second generation unit of an information processing apparatus and a label included in the learning data, wherein
the information processing apparatus includes:
a first generation unit configured to generate the synthesized image in which a second image is synthesized in a closed region in a first image; and
the second generation unit configured to generate the learning data, the learning data including the label and the synthesized image, the label indicating the object region including a region corresponding to the closed region in the synthesized image.

13. An image recognition apparatus, comprising
a detection unit configured to detect an object region from an input image using a detection unit learned by a learning apparatus that includes learning unit, the learning unit performing learning of the detection unit that detects the object region from the input image using a synthesized image included in learning data generated by a second generation unit of an information processing apparatus and a label included in the learning data, wherein
the information processing apparatus includes:
a first generation unit configured to generate the synthesized image in which a second image is synthesized in a closed region in a first image; and
the second generation unit configured to generate the learning data, the learning data including the label and the synthesized image, the label indicating the object region including a region corresponding to the closed region in the synthesized image.

14. A learning apparatus, comprising
a learning unit configured to perform learning of a first detection unit and a second detection unit using a synthesized image included in learning data generated by a second generation unit of an information processing apparatus, a label included in the learning data, and a texture label included in the learning data, the first detection unit detecting an object region from an input image, the second detection unit detecting a region having a texture from the input image, wherein
the information processing apparatus includes:
a first generation unit configured to generate the synthesized image in which a second image is synthesized in a closed region in a first image; and
the second generation unit configured to generate the learning data, the learning data including the label and the synthesized image, the label indicating the object region including a region corresponding to the closed region in the synthesized image, wherein
the second generation unit generates the learning data including the label, the synthesized image, and the texture label indicating a region having the texture in the closed region in the synthesized image.

15. An image recognition apparatus, comprising
a formation unit configured to form a new object region using an object region detected from an input image using a first detection unit learned by a learning apparatus and a texture region detected from the input image using a second detection unit learned by the learning apparatus, the learning apparatus including a learning unit configured to perform learning of the first detection unit and the second detection unit using a synthesized image included in learning data generated by a second generation unit of an information processing apparatus, a label included in the learning data, and a texture label included in the learning data, the first detection unit detecting the object region from the input image, the second detection unit detecting a region having a texture from the input image, wherein
the information processing apparatus includes:
a first generation unit configured to generate the synthesized image in which a second image is synthesized in a closed region in a first image; and
the second generation unit configured to generate the learning data, the learning data including the label and the synthesized image, the label indicating the object region including a region corresponding to the closed region in the synthesized image, wherein
the second generation unit generates the learning data including the label, the synthesized image, and the texture label indicating a region having the texture in the closed region in the synthesized image.

16. An information processing method performed by an information processing apparatus, the method comprising:
generating a synthesized image in which a second image is synthesized in a closed region in a first image; and
generating learning data including a label and the synthesized image, the label indicating an object region including a region corresponding to the closed region in the synthesized image.

17. A learning method performed by a learning apparatus, comprising
performing learning of a detection unit that detects an object region from an input image using a synthesized image included in learning data generated in an information processing method and a label included in the learning data, wherein
the information processing method includes:
generating the synthesized image in which a second image is synthesized in a closed region in a first image; and
generating the learning data including the label and the synthesized image, the label indicating the object region including a region corresponding to the closed region in the synthesized image.

18. An image recognition method performed by an image recognition apparatus, comprising
detecting an object region from an input image using a detection unit learned by a learning method using a synthesized image included in learning data generated in an information processing method and a label included in the learning data, the learning method performing learning of the detection unit that detects the object region from the input image, wherein
the information processing method includes:
generating the synthesized image in which a second image is synthesized in a closed region in a first image; and
generating the learning data including the label and the synthesized image, the label indicating the object region including a region corresponding to the closed region in the synthesized image.

19. A learning method performed by a learning apparatus, comprising
performing learning of a first detection unit and a second detection unit using a synthesized image included in learning data generated in an information processing method, a label included in the learning data, and a texture label included in the learning data, the first detection unit detecting an object region from an input image, the second detection unit detecting a region having a texture from the input image, wherein
the information processing method includes:
generating the synthesized image in which a second image is synthesized in a closed region in a first image; and
generating the learning data including the label and the synthesized image, the label indicating the object region including a region corresponding to the closed region in the synthesized image, wherein
the generating generates the learning data including the label, the synthesized image, and the texture label indicating a region having the texture in the closed region in the synthesized image.

20. An image recognition method performed by an image recognition apparatus, comprising
forming a new object region using an object region detected from an input image using a first detection unit learned by a learning method and a texture region detected from the input image using a second detection unit learned by the learning method, the learning method performing learning of the first detection unit and the second detection unit using a synthesized image included in learning data generated in an information processing method, a label included in the learning data, and a texture label included in the learning data, the first detection unit detecting the object region from the input image, the second detection unit detecting a region having a texture from the input image, wherein
the information processing method includes:
generating the synthesized image in which a second image is synthesized in a closed region in a first image; and
generating the learning data including the label and the synthesized image, the label indicating the object region including a region corresponding to the closed region in the synthesized image, wherein
the generating generates the learning data including the label, the synthesized image, and the texture label indicating a region having the texture in the closed region in the synthesized image.

21. A non-transitory-computer-readable storage medium storing a computer program to cause a computer to function as:
a first generation unit configured to generate a synthesized image in which a second image is synthesized in a closed region in a first image; and
a second generation unit configured to generate learning data, the learning data including a label and the synthesized image, the label indicating an object region including a region corresponding to the closed region in the synthesized image.

22. A non-transitory-computer-readable storage medium storing a computer program to cause a computer to function as
a learning unit of a learning apparatus configured to perform learning of a detection unit that detects an object region from an input image using a synthesized image included in learning data generated by a second generation unit of an information processing apparatus and a label included in the learning data, wherein
the information processing apparatus includes:
a first generation unit configured to generate the synthesized image in which a second image is synthesized in a closed region in a first image; and
the second generation unit configured to generate the learning data, the learning data including the label and the synthesized image, the label indicating the object region including a region corresponding to the closed region in the synthesized image.

23. A non-transitory-computer-readable storage medium storing a computer program to cause a computer to function as
a learning unit of a learning apparatus configured to perform learning of a first detection unit and a second detection unit using a synthesized image included in learning data generated by a second generation unit of an information processing apparatus, a label included in the learning data, and a texture label included in the learning data, the first detection unit detecting an object region from an input image, the second detection unit detecting a region having a texture from the input image, wherein
the information processing apparatus includes:
a first generation unit configured to generate the synthesized image in which a second image is synthesized in a closed region in a first image; and
the second generation unit configured to generate the learning data, the learning data including the label and the synthesized image, the label indicating the object region including a region corresponding to the closed region in the synthesized image, wherein
the second generation unit generates the learning data including the label, the synthesized image, and the texture label indicating a region having the texture in the closed region in the synthesized image.

24. A non-transitory-computer-readable storage medium storing a computer program to cause a computer to function as each unit of an image recognition apparatus, the image recognition apparatus comprising
a detection unit configured to detect an object region from an input image using a detection unit learned by a learning apparatus that includes a learning unit, the learning unit performing learning of the detection unit that detects the object region from the input image using a synthesized image included in learning data generated by a second generation unit of an information processing apparatus and a label included in the learning data, wherein
the information processing apparatus includes:
a first generation unit configured to generate the synthesized image in which a second image is synthesized in a closed region in a first image; and
the second generation unit configured to generate the learning data, the learning data including the label and the synthesized image, the label indicating the object region including a region corresponding to the closed region in the synthesized image.

25. A non-transitory-computer-readable storage medium storing a computer program to cause a computer to function as each unit of an image recognition apparatus, the image recognition apparatus comprising
a formation unit configured to form a new object region using an object region detected from an input image using a first detection unit learned by a learning apparatus and a texture region detected from the input image using a second detection unit learned by the learning apparatus, the learning apparatus including a learning unit configured to perform learning of the first detection unit and the second detection unit using a synthesized image included in learning data generated by a second generation unit of an information processing apparatus, a label included in the learning data, and a texture label included in the learning data, the first detection unit detecting the object region from the input image, the second detection unit detecting a region having a texture from the input image, wherein
the information processing apparatus includes:
a first generation unit configured to generate the synthesized image in which a second image is synthesized in a closed region in a first image; and
the second generation unit configured to generate the learning data, the learning data including the label and the synthesized image, the label indicating the object region including a region corresponding to the closed region in the synthesized image, wherein
the second generation unit generates the learning data including the label, the synthesized image, and the texture label indicating a region having the texture in the closed region in the synthesized image.
